(19) United States
(12) Patent Application Publication
(10) Pub. No.: US 2013/0205847 A1
(43) Pub. Date: Aug. 15, 2013

(54) SAFETY KEY DEVICE

(71) Applicant: Darren SOLAN, Sallins (IE)

(72) Inventor: Darren SOLAN, Sallins (IE)

(21) Appl. No.: 13/761,592

(22) Filed: Feb. 7, 2013

(30) Foreign Application Priority Data
Feb. 10, 2012 (GB) GB1202372.7

(51) Int. Cl. E05B 65/00; E05B 19/00

(52) U.S. Cl. CPC E05B 65/0014; E05B 19/00
USPC 70/395

(57) ABSTRACT

The present/invention comprises a key device (1) for insertion into a lock, the device being switchable between two modes of operation when inserted in the lock; wherein when the key device (1) is in its first mode of operation, the device prevents the lock from being activated between its engaged and disengaged positions; and when the key device (1) is in its second mode of operation, the device enables the lock to be activated between its engaged and disengaged positions; and wherein the key device is switchable between the two modes of operation by the application of a force to the key device (1) above a predetermined threshold.

### FIELD OF THE INVENTION

This invention relates to a key device for use with a locking mechanism which prevents the locking mechanism from being activated unless a sufficient force is applied to the device.

### BACKGROUND TO THE INVENTION

A common problem associated with key activated locking mechanisms or locks, such as those that are provided on a door or window, relates to the fact that the key is removable from the lock, and therefore may be misplaced. Not only is a lost key a source of inconvenience, but it can also result in more serious issues, for example should a young child lock themselves into a room, or a person be prevented from opening a window in the event of fire.

Devices which are adapted to be fitted to deadbolts of doors in order to prevent the deadbolt from being activated or deactivated unless a pressure is applied to the device are known. Such devices are however only suitable for deadbolt locks which have a mechanism known as a deadbolt actuator knob on the interior side of a door that can be manually turned to lock and unlock the deadbolt.

Complex lock and handle mechanisms which will only allow a door to be opened upon application of a threshold force to the handle are also known. Such mechanisms are cumbersome and are extremely expensive to machine and install. Such devices also necessitate the replacement of the entire lock and handle mechanism.

Object of the Invention

The object of the present invention is to provide a key device which prevents a locking mechanism from being activated until a predetermined “child safe” pressure is applied to the device, and which can be custom fitted or retrofitted to existing locking mechanisms, and which is suitable for use with many types of locking mechanisms. Furthermore, the key device of the present invention is adapted so that it cannot be readily removed from a locking mechanism.

### SUMMARY OF THE INVENTION

The present invention comprises a key device for insertion into a lock, the device being switchable between two modes of operation when inserted in the lock; wherein when the key device is in its first mode of operation, the device prevents the lock from being activated between its engaged and disengaged positions; and when the key device is in its second mode of operation, the device enables the lock to be activated between its engaged and disengaged positions; and wherein the key device is switchable between the two modes of operation by the application of a force to the key device above a predetermined threshold.

The key device may be switchable from the first mode to the second mode by the application of a force to the device in a direction towards the lock and the device is switchable from the second mode to the first mode by the application of a force to the device in a direction away from the lock.

The key device may further comprise a first part for insertion into the lock; a second part connected to the first part; a third part engagable with the second part; whereby in the first mode, the third part is disengaged from the second part such that the third part freely rotates around the second part and in the second mode, the third part is engaged with the second part such that the third part rotates in unison with the second part; and a fourth part secured to the third part; wherein the device is switchable between the first and second modes by the application of the force to the fourth part.

The key device may further comprise an elongate rotatable shaft to which is attached at least one protrusion arranged to engage with a lock.

The second part may comprise a recessed area about its outer circumference for engaging an engagement element located in the third part in order to engage the second part with the third part when the device is switched into its second mode.

The third part of the device may have a channel to accommodate the second part and further comprises a plurality of protrusions about its outer surface for receiving corresponding channels in the inner surface of the fourth part.

The key device may further comprise a first part for insertion into the lock; an inner part connected to the first part; an outer part engageable with the inner part; whereby in the first mode, the outer part is disengaged from the inner part such that the outer part freely rotates about the inner part and in the second mode, the outer part is engaged with the inner part such that the outer part rotates in unison with the inner part; and wherein the device is switchable between the first and second modes by the application of the force to the outer part.

The first part of the key device may further comprise an elongate rotatable shaft to which is attached at least one protrusion arranged to engage with a lock.

The inner part may further comprise a recessed area about its outer circumference for engaging an engagement element located in the outer part in order to engage the inner part with the outer part when the device is switched into its second mode.

The outer part of the device may be shaped to accommodate the inner part.

The key device may further comprise a biasing means located in the outer part wherein the restoring force of the biasing means defines the threshold force necessary to engage and disengage the inner part from the outer part.

The key device may further comprise an inner part for engaging with the lock; an outer part at least partially surrounding the inner part; a pivotable engaging means located within the outer part; whereby in the first mode of operation, the pivotable engaging means engages in a recess in the lock mechanism and prevents rotation of the outer part; and in the second mode, the pivotable engaging means is disengaged from the recess so as to allow rotation of the outer part; and wherein the device is switchable between the first and second modes by application of a force to the inner part.

The pivotable engaging means of the device may further engage with the lock by means of a protrusion on the engaging means engaging with a biased block on the lock so as to engage the protrusion against the biasing action of the block.

The biased block on the lock may be a spring-biased block.

The key device may further comprise a barrel section positioned within the outer part, wherein the application of the force to the inner part drives the barrel section against the pivotable engaging mechanism.

The key device may be fitted to a door lock. The key device may be fitted to a window lock.

### BRIEF DESCRIPTION OF THE DRAWINGS

FIG. 1 shows an exploded view of the first embodiment of the device of the invention showing the component parts;

FIGS. 2A, B, C, D show a series of views of the first part of the first embodiment of the device;

FIGS. 3A, B, C, D, E show a series of views of the second part of the first embodiment of the device;

FIGS. 4A, B, C, D, E show a series of views of the third part of the first embodiment of the device;

FIGS. 5A, B, C, D, E show a series of views of the fourth part of the first embodiment of the device;

FIGS. 6A, B, C shows a series of views of the first embodiment of the device;

FIGS. 7A, B, C, D show a series of views of the device in situ on a typical door handle;

FIG. 8 shows an exploded view of the second embodiment of the device showing the component parts;

FIGS. 9A and B show exploded views of the second embodiment of the device showing the component parts;

FIGS. 10A, B, C, D, E show a series of views of the inner part of the second embodiment of the device;

FIGS. 11A, B, C, D, E show a series of views of the outer part of the second embodiment of the device;

FIGS. 12A, B, C show a series of views of the second embodiment of the device.

FIGS. 13A, B, C, D show a series of views of the second embodiment of the device in situ on a typical door handle.

FIG. 14 shows a view of an alternative shape of the outer piece of the second embodiment

FIG. 15 shows a view of the third embodiment of the device.

FIG. 16 shows an exploded view of the inner piece, the torsion spring and the barrel of the third embodiment

FIG. 17 shows a cutaway view of the third embodiment in the safe mode, where opening of the lock is prevented.

FIG. 18 shows a cutaway view of the third embodiment in the key mode, where opening of the lock is possible.

### DETAILED DESCRIPTION

The present invention will now be described with reference to the accompanying drawings. The construction of the device will first be described followed by a description of the device in use.

FIG. 1 shows one embodiment of the key device 1 of the present invention and its component parts. The device 1 comprises of four main different component parts, namely a first part 35, a second part 3, a third part 9 and a fourth part 16 and a number of interconnecting screws 2, 6. In the embodiment of the device described below, the device is being inserted into a locking mechanism which may be activated from both sides, such as a door. Therefore, when the key device 1 is coupled to the door there will be one first part 35, two second parts 3, two third parts 9 and two fourth parts 16, as shown in FIG. 1. However, when the device 1 is coupled to an opening such as window, it will be appreciated there will be only one of each of the second, third and fourth parts The first part will not be required to couple to an opening such as a window. Instead, the second, third and fourth parts can be either retrofitted to an existing window key or fitted to a shaft portion which can engage with a recess to provide a locking mechanism.

The first part 35 is the component which provides the locking element for engaging with a locking mechanism to which the key device is to be inserted. In the described embodiment, it comprises an elongate shaft to which at least one protrusion, such as teeth 34 are attached substantially at its centre and dividing the shaft into two portions 32, 33, with the teeth 34 arranged so as to engage with a locking mechanism to which the key device is to be inserted.

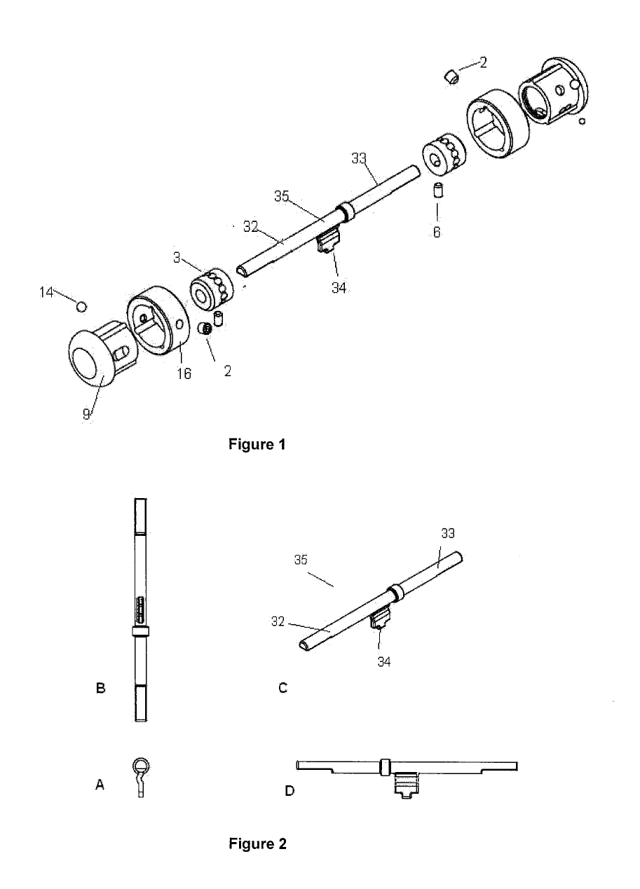

The first part 35 of the present invention (See FIG. 2) may be fabricated by modifying a typical key. A typical key consists of a bow end, which is held and turned by a user, an elongate shaft portion which is generally cylindrical, and a toothed end which engages with a locking mechanism. Accordingly, it will be understood that the first part 35 of the present invention may be fabricated by removing the bow end from a typical key so that the elongate shaft portion 32 remains, and attaching a further shaft portion 33 to the toothed end, such that the teeth 34 are substantially centred on the elongate shaft formed by the two portions 32 and 33. A typical key can therefore be modified in this manner to provide the first part 35 of the key device 1. Alternatively, if the device is not be retrofitted to an existing lock, the entire first part 35 of the device may be specifically manufactured. In this case, it will be appreciated that the first part 35 can simply comprise an elongate shaft with no teeth, as there is no pre-existing locking mechanism with which the first part 35 must engage by means of the teeth. In this manner, the need for a more complex shaped key and lock arrangements is obviated.

The second part 3 of the device, as seen further in FIG. 3 is substantially cylindrical in shape. A circular opening 4 extends through the centre of the second part 3 to receive the free end of either shaft 32 or shaft 33 of the first part 35, as explained above. The first part 35 is connected to each second part 3 by a fastening means in the form of a screw 6 which can be inserted and tightened through an aperture 7 in the second part 3. The second part 3 is also provided with a plurality of recesses 8 which surround its outer surface.

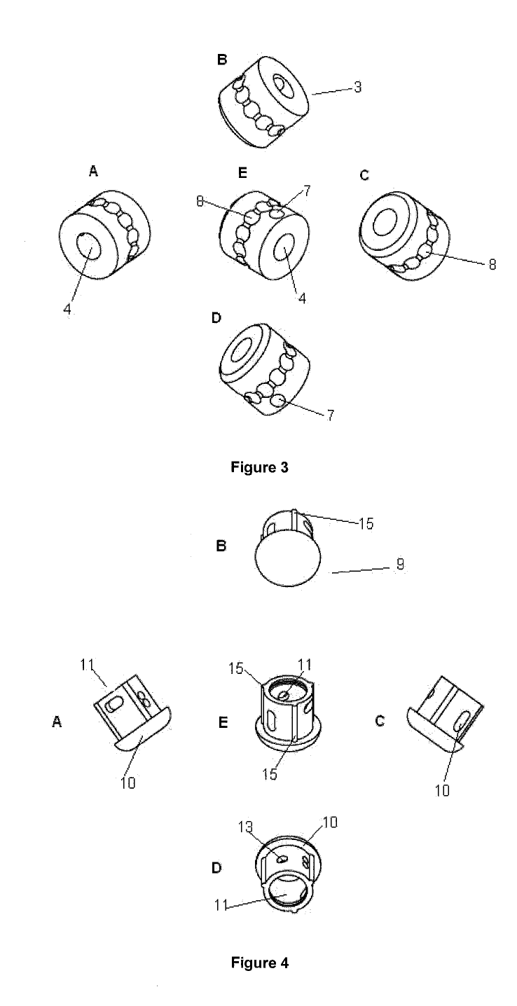

The third part 9 of the device, as seen further in FIG. 4, is substantially cylindrical in shape, and has a closed hollow internal channel dimensioned to accommodate the second part 3. One end of the third part 9 is open and the other end has a capped top 10. In the described embodiment of the invention, when the second part 3 is placed within the channel through the open end 11 of the third part 9, it is prevented from slipping out by a circlip. It will be appreciated that any other device that serves a similar purpose as a circlip could equally well be used in place of the circlip. When the second part 3 is located within the third part 9, rotation is permitted between the second part 3 and third part 9, but lateral movement is prevented.

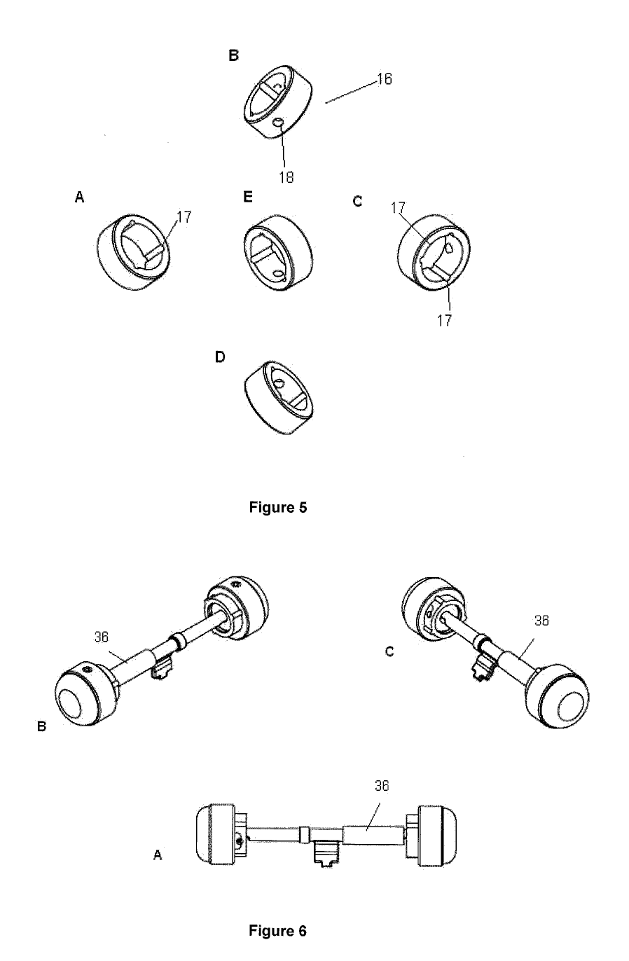

The third part 9 is provided with an aperture 13 in its outer surface which is adapted to accommodate an engagement element in the form of a ball bearing 14. The third part 9 is also provided with a plurality of protrusions in the form of raised ribs 15 arranged spaced apart about its outer surface, extending from top to bottom. The raised ribs 15 of the third part 9 allow for the slotting of the third part 9 into a corresponding arrangement of recessed channels 17 provided in an open ended hollow cylinder forming the fourth part 16 of the device (see FIG. 5). When the ribs 15 of the third part 9 are slotted in to the channels 17 of the fourth part 16, the third part 9 and the fourth part 16 are prevented from being rotated relative to each other. The fourth part 16 is then secured in place to the third part 9 by a fastening means in the form of screw 2 which can be inserted and tightened through an aperture 18 in the fourth part.

As previously explained, it can be seen in FIG. 1 that each of the second part 3, third part 9 and fourth part 16 are fixed to the ends of both shaft portions 32, 33 of the first part 1 in the manner described above.

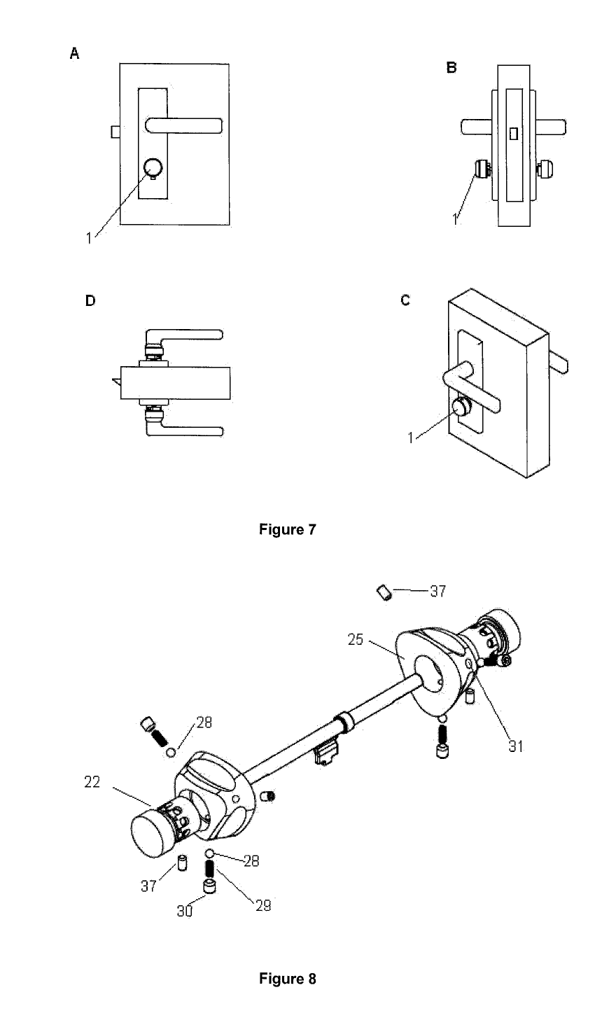

FIG. 6 shows the key device 1 prior to it being inserted into the locking mechanism of a door or other opening with which it is to be used. The shaft 32 has a limiting means in the form of a collar 36. The collar 36 is positioned on the shaft 32 so that it limits movement of the key device 1 within the locking mechanism to which it is inserted, and ensures that the teeth 34 remain in the correct position for engaging with the locking mechanism. Once a device has been inserted into a lock, it is not possible to separate the device from the lock without physically dismantling the device. As such, the insertion of the device 1 into a lock removes the problem and potentially serious issues associated with “lost keys”, whereby a key for a lock may be easily removed and misplaced. FIG. 7 shows the device 1 when inserted into one typical type of a lock for a door. However, it will be appreciated that the device could equally well be used in conjunction with many different types of locks, and for many type of openings, for example the device may be fitted to a lock for a window or to a lock for a lockable container.

Inserting the device into a locking mechanism is described in relation to a door of the type shown in FIG. 7. A typical lock mechanism of the type described in FIG. 7 will have an opening to receive a key. The device may be inserted into the locking mechanism of the door by securing the second, third and fourth part to one end of the elongate shaft of the first part and feeding the opposite end of the elongate shaft through the opening on one side of the door, such that the end of the elongate shaft passes all the way through the opening to the other side of the door. The second, third and fourth part of the device are then secured to the end of the elongate shaft that has been passed through the opening. Once a device has been inserted into a lock in this manner, it is not possible to separate the device from the lock without physically dismantling the device as the secured second, third and fourth parts of the device will not pass through the opening. As such, the Inserting of the device 1 to a lock removes the problem of “lost keys”, whereby a key for a lock may be easily removed and misplaced.

The key device 1, once inserted into a lock or locking mechanism, has two modes of operation, a key mode, and a safe mode. In key mode the device enables the lock to be activated between its engaged or locked and disengaged or unlocked positions, while in safe mode the device prevents a lock from being engaged or disengaged. The key device is switchable between the two modes of operation by exerting a force upon the device above a predetermined threshold, with the direction of the force determining which of the two modes the device switches to. It will understood that when a lock is in the engaged position, the door or other opening to which the lock is attached is locked, while when a lock is in the disengaged position, the door or other opening to which the lock is attached is unlocked.

To switch the key device from safe mode into key mode, a force above a threshold is applied to the fourth part 16 so that the fourth part 16 is pushed in a direction towards the lock in which the key device is inserted. This results in the ball bearing 14 (as shown in FIG. 1), accommodated in the aperture 13 in the outer surface of the third part 9 engaging into any one of the plurality of recesses 8 of the second part 3. This in turn allows a turning action applied to the third part 9 and the fourth part 16 to activate the lock by transferring a turning force to the second part 3, as the third part 9 and second part 3 are now engaged to rotate in unison, and therefore a turning force is transferred to the first part 35 (or locking element) to which the second part 3 is connected.

To switch the device from key mode into safe mode, a force above a threshold is applied to the fourth part 16 of the key device such that it is pulled in a direction away from the lock. This force disengages the ball bearing 14 from its location within one of the plurality of recesses 8 of the second part 3. With the ball bearing 14 now disengaged from the recesses 8 of the second part 3, a turning action applied to the third part 9 and fourth part 16 does not activate the lock, as this turning force is not transferred to the second part 3, which is of course connected to the first part 35. As such, the third 9 and fourth parts 16 can be rotated freely without transferring a turning force to activate the lock.

The device may be changed from safe mode back in key mode by applying a force above the threshold towards the lock to the fourth part 16. The threshold force can be adjusted by loosening or tightening a fastening means in the form of a screw 2. When the device is switched to either safe mode or key mode, it may be fixed in that mode by further tightening of the fastening means.

It will be appreciated that the predetermined force threshold or torque can be adjusted to be above a ‘child safe’ threshold, thus preventing young children from being able to activate the lock. Operating the device with such a threshold means that a door or other opening can be locked by an adult when the device is in key mode, and then the device can be subsequently switched into safe mode so that the lock can not be activated to disengage the lock. Thus the door or opening is locked and is now prevented from being unlocked by a child. Alternatively, the door or opening can be unlocked by an adult when the device is in key mode, and then the device can be subsequently switched into safe mode so that the lock can not be activated. Thus the door or opening is unlocked and is now prevented from being locked by a child.

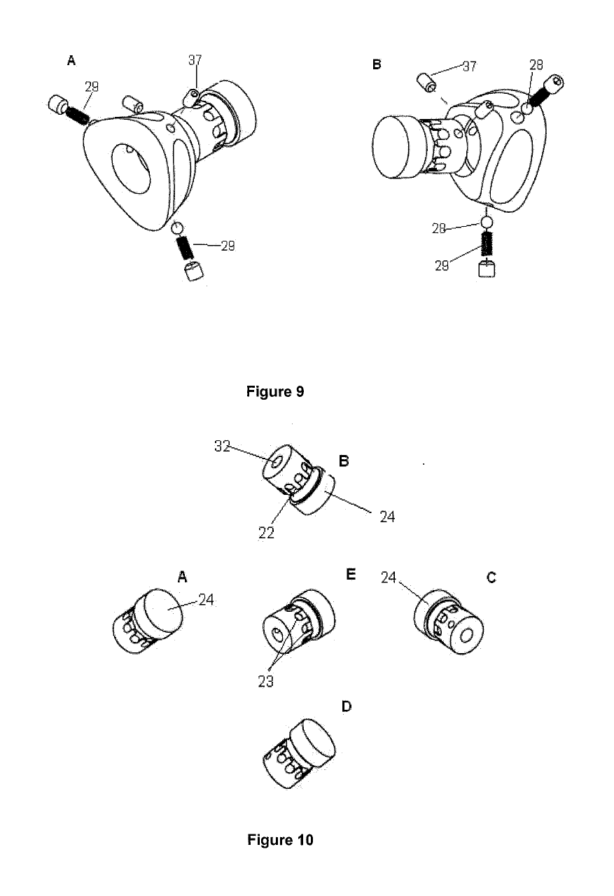

FIGS. 8 and 9 show a series of exploded views of a second embodiment of the key device 1 of the present invention. The functionality of the second embodiment of the device is the same as the first embodiment of the device, however the component parts are different.

The second embodiment is comprised of three different main component parts, a first part 35, an inner part 22, and an outer part 25, and a number of interconnecting screws. The first part 35 or locking element is identical to the first part of the first embodiment, and consists of teeth for engaging with a locking mechanism in which the device is inserted, with the teeth being substantially centred on an elongate shaft comprised of two portions 32, 33.

The inner part 22 of the device is connected to the first part 35. FIG. 10 shows a perspective view of the inner part 22 of the device. It is substantially cylindrical in shape and comprises a recessed area formed by a plurality of U-shaped recesses 23 spaced about its outer surface. Extending through the centre of the inner part 22 is a channel 32 closed at one end by a capped top 24. The capped top 24 has a wider circumference than the open end of the channel 32.

FIG. 11 shows the outer part 25 of the device of the second embodiment. It has an internal closed circular channel 26 dimensioned to receive the inner part 22. A limiting means in the form of a raised lip 27 around the inner circumference of the outer part 25 is adapted to be wide enough to receive both the open end 32 and the recessed area 23 of the inner part but to be sufficiently narrow to block the capped top 24 of the inner part 22 from passing though. In this manner, the inner part 22 may be partially located in the channel 26 of the outer part 25.

An engagement element in the form of a ball bearing 28, as seen in FIGS. 8 and 9, is held in place in an aperture 31 of the outer part 25 by a tensioning means in the form of a compressed spring 29 which is positioned on top of the ball bearing 28. The spring 29 is further held in place by a screw 30 positioned over the spring. It will be appreciated that a plurality of ball bearing and aperture pairs may be located on the outer part 25 for additional security. The pairs should preferably be located at equally spaced apart intervals about the surface of the outer part 25. In the embodiment shown in the drawings, it can be seen that a second ball bearing is held in place in the same manner in an aperture located at a spaced apart interval from the aperture 31.

The pressure on the bearing 28 can be adjusted depending on the restoring force of the compressed spring 29. The pressure on the bearing will determine the threshold force required to switch between the modes of operation of the device as described below. The threshold force can be adjusted by loosening or tightening the screw 30. The threshold force can also be adjusted by use of different springs with different restoring forces.

This key device of the second embodiment, like the first embodiment, is switchable between two modes of operation, namely a key mode, in which it is possible to activate the device to engage or disengage a locking mechanism in which it is inserted, and a safe mode, where the device prevents a locking mechanism from being activated between the engaged and disengaged positions.

The device is switched into key mode by applying a force above a predetermined threshold in a direction towards the lock by pushing against the outer part 25. This allows the ball bearing 28 held in the aperture 31 of the outer part 25 to engage into any one of the plurality of U-shaped recesses 23 in the recessed area of the inner part 22. This enables a turning action applied to the outer part 25 of the device to act on the first part 35 to which it is indirectly coupled by means of the inner part 22 to activate the locking mechanism, as the outer part and the inner part are now engaged to rotate in unison.

Conversely, the device may be switched from key mode into safe mode by applying a force above a predetermined threshold in a direction away from the lock by pulling the outer part 25 away from the inner part 22. This disengages the ball bearing 28 from location within one of the plurality of U-shaped recesses 23 of the inner part 22. With the ball bearing 28 now unable to engage in the recesses 23 of the inner part 22, a turning action applied to the outer part 25 prevents activation of the lock, as no turning force is transferred to the inner part 22, and in turn to the first part 35 inserted into the locking mechanism. As such, the outer part 25 may only be freely rotated without transferring a turning force to the inner part 22.

The device may be switched from safe mode back to key mode by applying a force above the threshold towards the lock to the outer part 22. When the device is switched to either safe mode or key mode, it may be fixed in that mode by tightening a fastening means in the form of a screw 37.

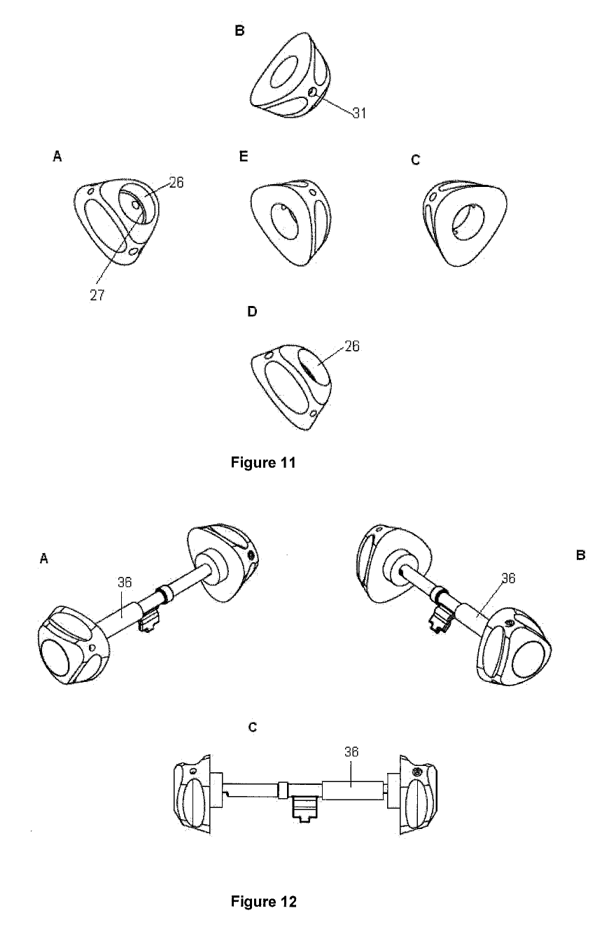

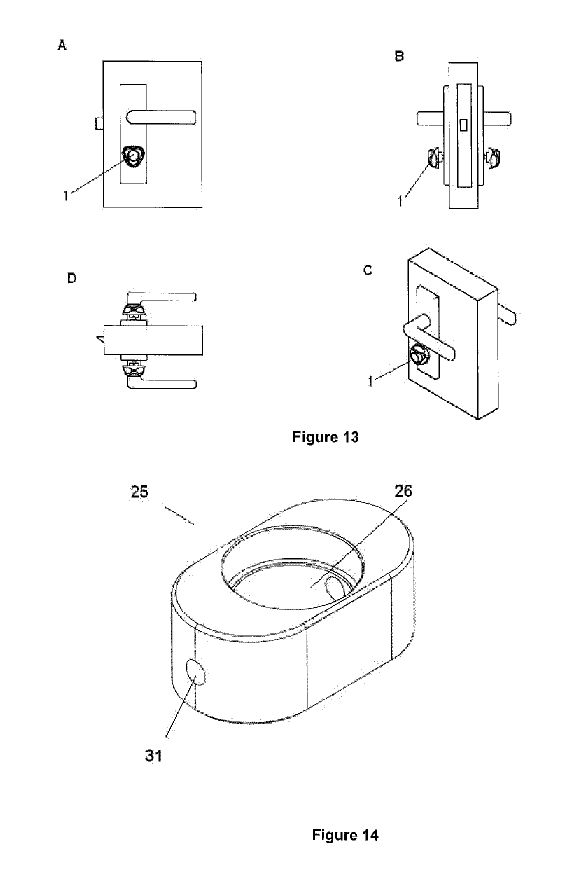

FIG. 12 shows the second embodiment of the key device 1 prior to it being inserted into the locking mechanism of a door or other opening with which it is to be used. The shaft has a limiting means in the form of a collar 36. FIG. 13 shows the second embodiment of the device 1 when coupled to a door handle.

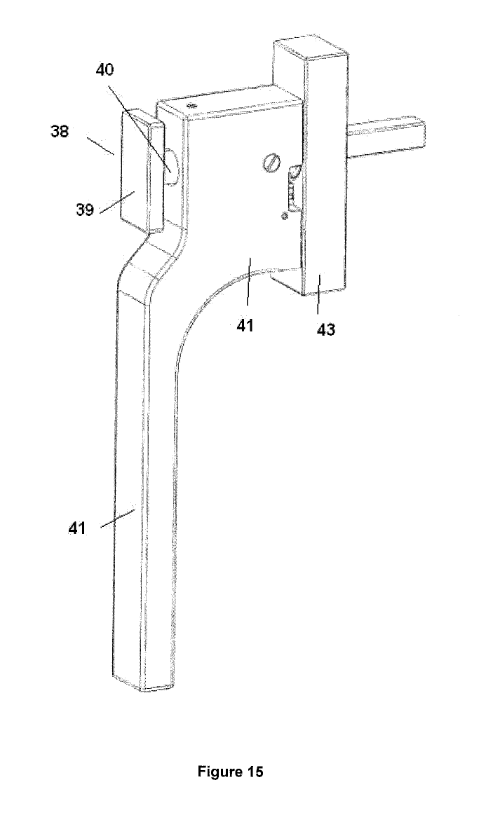

The outer part of the second embodiment may be shaped in a variety of ways. The outer part may be oblong shaped with curved end surfaces. One such shape is shown in FIG. 14.

FIGS. 15 to 18 show a further embodiment of the device. The functionality of the further embodiment of the device is the same as the other embodiments of the device, however some of the component parts are different.

This embodiment is particularly suited for use with a type of handle and lock typically found on windows.

As with the first two embodiments, the device is switchable between two modes of operation, namely a key mode, in which it is possible to activate the device to engage or disengage a lock or locking mechanism in which it is inserted, and a safe mode, where the device prevents a locking mechanism from being activated between the engaged and disengaged positions.

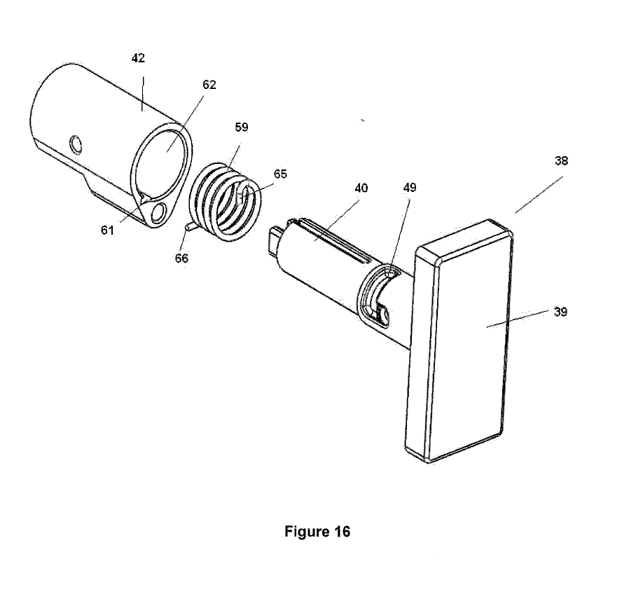

The device (FIG. 15) comprises an inner part 38 having a grip or knob 39 connected at one end of a cylindrical elongate section 40. An outer part 41, which surrounds the elongate section is handle shaped to facilitate turning by a user. The elongate section 40 is provided with an annular channel 49 (FIG. 16) at an intermediate portion along its surface. A force applied to the inner part 38 via the knob 39 allows for opening of the lock in the manner described below.

Within the outer part 41 (FIG. 16, 17), there is further housed a barrel section 42. The barrel section 42 is a hollow cylinder and is positioned horizontally within a cavity of the outer part 41. The barrel section 42 abuts an inner wall 60 of the outer part 41 at one end and a surface of a base plate 43 of a lock at the other end. The elongate section of the inner part is shaped to fit within the barrel section 42. A torsion spring 59 is located within the barrel section 42. The coils of the spring run partially along the length of the inner circumference of the barrel section 42. One end of the spring is affixed to the inner part 38 of the device. The other end abuts a recessed slot 61 on the inner surface 62 of the barrel.

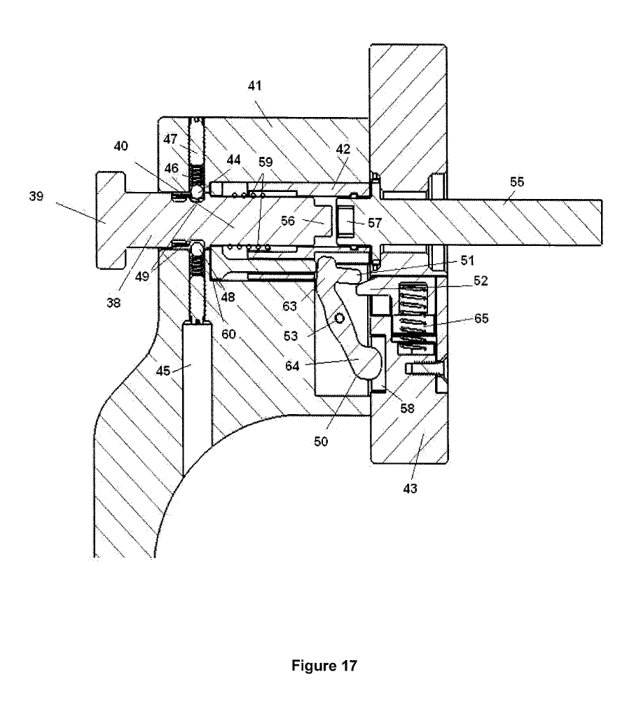

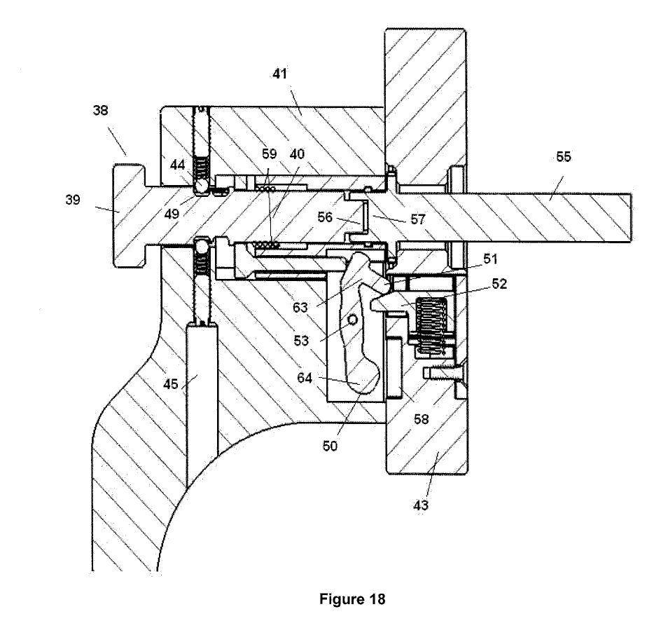

The outer part is further provided with an annular groove 45 which is located directly above the annular channel 49 of the inner part 38. An engagement element in the form of a ball bearing 44, as seen in FIGS. 17 and 18, is held in place in a groove 45 of the outer part by a tensioning means in the form of a compressed spring 46 which is positioned on top of the ball bearing 44. The spring 46 is further held in place by a screw 47 positioned over the spring 46. It will be appreciated that a plurality of ball bearing and aperture pairs may be located around the annular groove 45 of the outer part 41 for additional security. In the embodiment shown in the drawings, it can be seen that a second ball bearing 48 is held in place in the same manner opposite the first ball bearing 44 on the opposite side of the outer part 41.

The pressure on the bearing 44, 48 can be adjusted depending on the restoring force of the compressed spring 46. The pressure on the bearing 44, 48 will determine the threshold force required to switch between the modes of operation of the device as described below. The threshold force can be adjusted by loosening or tightening the screw 47. The threshold force can also be adjusted by use of different springs with different restoring forces.

To operate the device (FIG. 18), the knob 39 is firstly rotated. The device is then switched into key mode by applying a force above a predetermined threshold in a direction towards the lock by pushing against the knob 39. This allows the ball bearing held in the groove 45 of the outer part 41 to engage in the annular channel 49 of the elongate section 40 of the inner part.

The base plate 43 is provided with a recess 58 and a spring biased block 52 adapted to receive each end (63,64) of a rocker 50. The rocker 50 is encased within the outer part and is moveable between an engaged position, in which one end 64 is located within the recess 58 of the base plate (See FIG. 17) and a disengaged position in which the end 64 is disengaged from the base plate 43 (See FIG. 18). The rocker 50 in the outer part 41 is disengaged from the base plate 43 by the application of the same force as applied to the knob 39. In its engaged position, a protrusion 51 on one end 63 of the rocker 50 rests on the surface of the spring biased block 52 in the lock base plate 43 while the other end 64 of the rocker 50 is located in the recess 58. The rocker 50 is pivotable about a pin 53 which passes through the body of the rocker 50. Upon application of a force to the knob 39, the barrel section 42 is driven against the end 63 of the rocker 50. This causes the protrusion 51 on the rocker 50 to be pushed downwards by the application of the force. The protrusion 51 presses down on the surface of the spring biased block 52, which in turn acts against the bias of the spring 65 so as to hold the rocker 50 in its disengaged position, with the end 64 of the rocker disengaged from the recess 58. This enables a turning action applied to the knob 39 of the inner part 38 to act on and activate the lock 55, as the knob 39, outer part 41 and the lock 55 are now engaged to be rotatable in unison. The inner part is mated to the lock 55 by means of a male protrusion 56 on one end of the inner part 38 and a corresponding female recess 57 on one end of the lock 55.

Thus, applying a force in the direction towards the lock 55 causes the rocker 50 to disengage from the window lock base plate 43 allowing the (handle shaped) outer part 41 to rotate, and thus allowing the lock 55 to be turned opened.

To subsequently close the lock, a force is applied to the knob 39 and the outer part 41 is rotated such that the rocker 50 is once again brought into the engaged position in the recess 58 of the lock base plate 43.

The fact that the block 52 on the lock base plate 43 is spring loaded allows the rocker 50 to pivot back to its engaged position once the handle is brought back to a “closed” position, by means of the bias action of the spring within the block 52 acting on the protrusion 51. The block 52 further prevents lateral movement of the rocker 50 once it is in position in the recess 58 and thus prevents movement of the outer part 41.

The torsion spring 59 within the barrel section 42 provides a restoring force which returns the inner part 38 to the safe mode position when a force is not being applied to the inner part. As such, the lock cannot be turned opened or closed unless the knob 39 is once again rotated and a threshold force applied to the inner part 38.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A key device for insertion into a lock, the device being switchable between a first and a second mode of operation when inserted in the lock;
wherein when the key device is in its first mode of operation, the device prevents the lock from being activated between its engaged and disengaged positions; and
when the key device is in its second mode of operation, the device enables the lock to be activated between its engaged and disengaged positions; and
wherein the key device is switchable between the two modes of operation by the application of a force to the key device above a predetermined threshold.

2. The key device of claim 1, wherein the device is switchable from the first mode to the second mode by the application of a force to the device in a direction towards the lock, and the device is switchable from the second mode to the first mode by the application of a force to the device in a direction away from the lock.

3. The key device of claim 2, further comprising:
a first part for insertion into the lock;
a second part connected to the first part;
a third part engagable with the second part; whereby;
in the first mode, the third part is disengaged from the second part such that the third part freely rotates around the second part; and
in the second mode, the third part is engaged with the second part such that the third part rotates in unison with the second part; and
a fourth part secured to the third part; wherein the device is switchable between the first and second modes by the application of the force to the fourth part.

4. The key device of claim 3 wherein the first part comprises an elongate rotatable shaft to which is attached at least one protrusion arranged to engage with a lock.

5. The key device of claim 3 wherein the second part comprises a recessed area about its outer circumference adapted to engage with an engagement element located in the third part when the device is switched from the first mode to the second mode.

6. The key device of claim 3 wherein the third part has a channel to accommodate the second part and a plurality of protrusions about its outer surface for receiving corresponding channels in the inner surface of the fourth part to secure the third part to the fourth part.

7. The key device of claim 2, further comprising:
a first part for insertion into the lock;
an inner part connected to the first part; and
an outer part engageable with the inner part;
whereby in the first mode, the outer part is disengaged from the inner part such that the outer part freely rotates about the inner part; and in the second mode, the outer part is engaged with the inner part such that the outer part rotates in unison with the inner part; and
wherein the device is switchable between the first and second modes by the application of the force to the outer part.

8. The key device of claim 7 wherein the first part comprises an elongate rotatable shaft to which is attached at least one protrusion arranged to engage with a lock.

9. The key device of claim 8 wherein the inner part comprises a recessed area about its outer circumference adapted to engage with an engagement element located in the outer part when the device is switched from the first mode to the second mode.

10. The key device of claim 7 wherein the outer part is shaped to accommodate the inner part.

11. The key device of claim 7 further comprising a biasing means located in the outer part wherein the restoring force of the biasing means defines the threshold force necessary to engage and disengage the inner part from the outer part.

12. The key device of claim 1, further comprising:
an inner part for engaging with the lock;
an outer part at least partially surrounding the inner part;
a pivotable engaging means located within the outer part;
whereby in the first mode of operation, the pivotable engaging means engages in a recess in the lock and prevents rotation of the outer part;
and in the second mode, the pivotable engaging means is disengaged from the recess so as to allow rotation of the outer part;
and wherein the device is switchable between the first and second modes by application of a force to the inner part.

13. The key device of claim 12 wherein the pivotable engaging means further engages with the lock by means of a protrusion on the engaging means engaging with a biased block on the locking mechanism so as to engage the protrusion against the biasing action of the block.

14. The key device of claim 13 wherein the biased block is a spring biased block.

15. The key device of claim 12 further comprising:
a barrel section positioned within the outer part, wherein the application of the force to the inner part drives the barrel section against the pivotable engaging mechanism.

16. The key device of claim 1 fitted to a door lock.

17. The key device of claim 1 fitted to a window lock.
